(19) United States
(12) Patent Application Publication
(10) Pub. No.: US 2013/0186138 A1
(43) Pub. Date: Jul. 25, 2013

(54) APPARATUS AND METHOD FOR FORMING GLASS SHEETS

(71) Applicants: Troy R. Lewandowski, Maumee, OH (US); David B. Nitschke, Perrysburg, OH (US); Dean M. Nitschke, Maumee, OH (US); Jeffrey A. Grzeszczak, Sylvania, OH (US); Mace L. Odneal, Rossford, OH (US)

(72) Inventors: Troy R. Lewandowski, Maumee, OH (US); David B. Nitschke, Perrysburg, OH (US); Dean M. Nitschke, Maumee, OH (US); Jeffrey A. Grzeszczak, Sylvania, OH (US); Mace L. Odneal, Rossford, OH (US)

(73) Assignee: GLASSTECH, INC., Perrysburg, OH (US)

(21) Appl. No.: 13/357,700

(22) Filed: Jan. 25, 2012

(51) Int. Cl. C03B 11/12; C03B 11/00; C03B 11/06

(52) U.S. Cl. 65/29.19; 65/273; 65/162; 65/106

(57) ABSTRACT

Apparatus (36, 36′) and a method for forming glass sheets utilizes a press ring assembly (50) adjacent a heating furnace to receive a heated class sheet therefrom for press forming. The press ring assembly (50) includes a press ring (52) for mounting on a support (48), with the press ring having an open interior and peripheral shape including an upwardly oriented forming face (74) for contacting the heated glass sheet periphery. A heater (75) extends along the peripheral shape of the press ring (52) to provide heating under the control of at least one thermocouple (110), and insulation (78) extends along the periphery of the press ring within the interior, around the exterior and below the press ring to reduce heat loss, with the heater located between the insulation and the press ring. An upper press mold (58) cooperates with the press ring assembly (50) to provide press forming.

### TECHNICAL FIELD

This invention relates to an apparatus and a method for forming glass sheets.

### BACKGROUND

Glass sheets after heating have previously been formed by conveyance on a lower roll bed to above a forming mold that is moved upwardly to provide the forming, see U.S. Pat. No. 6,543,255. The roll bed can include wheels or, as disclosed in United States patent Publication No. US 2011/0247367, filed on Apr. 8, 2010 under the title PRESS BENDING STATION AND METHOD FOR BENDING HEATED GLASS SHEETS by David B. Nitschke et al., can include elongated rollers or can include wheels and elongated rollers that are selectively attachable and detachable for rotational driving and positioning to provide the required shape for the mold to move vertically from below to above the conveyor for lifting of the heated glass sheet for the forming. The above referenced patent and published application are hereby incorporated by reference.

### SUMMARY

An object of the present invention is to provide improved apparatus for forming glass sheets.

In carrying out the above object, the apparatus for forming glass sheets according to the invention includes a press ring assembly located adjacent a heating furnace to receive a heated glass sheet therefrom for forming. The press ring assembly includes a press ring for mounting on a support and the press ring has an open interior and a peripheral shape including an upwardly oriented forming face for contacting the periphery of the heated glass sheet. A heater extends along the peripheral shape of the press ring to provide heating of the press ring. Insulation extends along the periphery of the press ring within the interior, around the exterior and below the press ring to reduce heat loss from the press ring, and the heater is located between the insulation and the press ring.

The glass sheet forming apparatus as disclosed includes an upper mold that cooperates with the press ring assembly to press form the heated glass sheet. A roll conveyor of one embodiment of the disclosed apparatus conveys a preformed glass sheet to above the press ring assembly for additional forming by pressing between the press ring assembly and the upper mold, while a roll conveyor of another embodiment of the disclosed apparatus conveys a flat glass sheet to above the press ring assembly for forming by pressing between the press ring assembly and the upper mold.

A thermocouple of the press ring assembly senses the press ring temperature.

The press ring assembly as disclosed has a heater including heater portions both within the interior and around the exterior of the press ring between the insulation and press ring.

The press ring as disclosed includes a cross section having a vertical stem and an enlarged head defining the upwardly oriented forming face that contacts the heated glass sheet to provide the forming. The enlarged head of the press ring cross section has an inner portion that extends from the stem toward the interior of the press ring, and the enlarged head of the press ring cross section has an outer portion that extends from the stem toward the exterior of the press ring.

The press ring as disclosed includes connections that secure the heater portions to the stem of the press ring below the inner and outer portions of its enlarged head. Each connection includes a shaft that extends through the stem of the press ring and has inner and outer ends, and each connection has inner and outer retainers respectively secured to the inner and outer ends of the shaft to respectively secure the heaters within the interior and around the exterior of the press ring.

The press ring assembly as disclosed includes insulation positioners within the interior of the press ring and at the exterior of the press ring to position the insulation on the press ring. Connectors of the press ring assembly secure the insulation positioners to the stem of the press ring.

The press ring assembly as disclosed includes a plurality of thermocouples mounted at spaced locations from each other on the press ring to sense the temperature of the press ring. More specifically, the thermocouples disclosed are located between the press ring and the heater portions around the exterior of the press ring. These thermocouples are disclosed as being mounted by contact with the heater portions around the exterior of the press ring and by contact with both the stem of the press ring and the outer portion of the enlarged head of the press ring at a lower surface of the outer portion. The apparatus also includes a controller for controlling the heater in response to the temperature of the press ring sensed by the thermocouples.

Another object of the present invention is to provide an improved method for forming a glass sheet.

In carrying out the immediately preceding object, the improved method for forming a glass sheet is performed by: heating the glass sheet within a furnace to a forming temperature; heating a press ring of a forming station adjacent the furnace, which press ring has insulation at an interior, an exterior, and a lower surface of the press ring, to a temperature so an exposed upper forming face of the press ring approximates the forming temperature of the periphery of the heated glass sheet; and transferring the heated glass sheet from the furnace to the forming station above the press ring for forming.

As disclosed, the forming of the heated glass sheet is performed between the press ring and an upper mold by relative vertical movement between the press ring and the upper mold.

The press ring as disclosed is heated by a heater having heater portions that extend along the interior and exterior of the press ring and that are controlled by at least one thermocouple that senses the temperature of the press ring. As disclosed, the heating of the press ring is controlled by a plurality of thermocouples mounted on the press ring at spaced locations from each other.

More specifically, the forming of the heated glass sheet is performed between the press ring and an upper mold by relative vertical movement between the press ring and the upper mold, the press ring is heated by a heater having heating portions that extend along the interior and exterior of the press ring and that are controlled by a plurality of thermocouples mounted on the press ring at spaced locations from each other.

### BRIEF DESCRIPTION OF THE DRAWINGS

FIG. 1 is a schematic side elevational view of one embodiment of a glass sheet forming system that includes forming apparatus constructed according to and performing the method of the present invention.

FIG. 2 is a schematic cross sectional view through the system taken along the direction of line 2-2 in FIG. 1 at an exit end of a furnace of the system and illustrates horizontal and inclined rolls on which heated glass sheets are conveyed for initial roll forming prior to exiting the furnace in preparation for further forming.

FIG. 3 is a schematic cross sectional view taken through the system along line 3-3 in FIG. 1 at its forming station to illustrate the construction of a lower press ring assembly provided by a press ring and also illustrating the construction of an upper press mold, which press ring and press mold are movable as disclosed between the solid and phantom line indicated positions to press bend the initially roll formed glass sheet.

FIG. 4 is a view of another embodiment of the glass sheet forming system whose forming station forms a flat glass sheet according to the invention.

FIG. 5 is a cross-sectional view taken along the direction of line 5-5 in FIG. 4 to further illustrate the flat shape of the glass sheet during the positioning prior to its forming.

FIG. 6 is a top plan view illustrating the press ring assembly of the forming station and showing the press ring assembly as including a press ring and insulation that surrounds the press ring to reduce heat loss form the press ring.

FIG. 7 is a cross sectional view of the press ring assembly taken along line 7-7 in FIG. 6 to illustrate the manner in which heaters and insulation are secured to the press ring.

FIG. 8 is a perspective view of a portion of the press ring to further illustrate the construction of the press ring assembly.

### DETAILED DESCRIPTION OF THE PREFERRED EMBODIMENTS

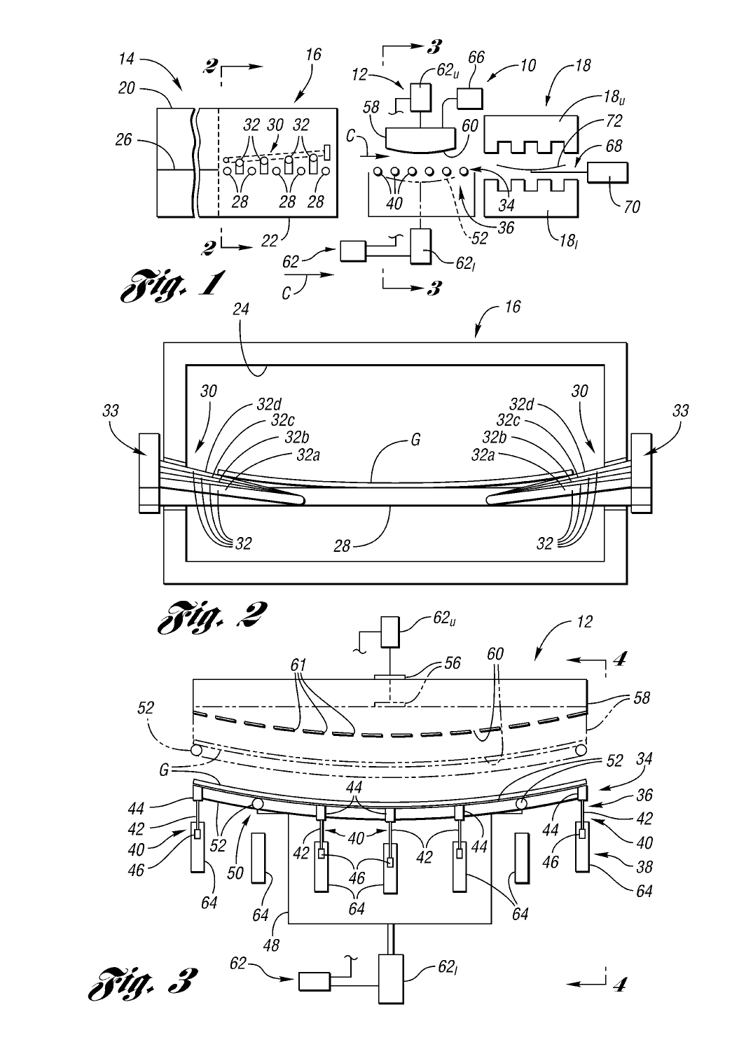

With reference to FIG. 1 of the drawings, one embodiment of a system for forming glass sheets is generally indicated by 10 and includes a forming station 12 for forming glass sheets in accordance with the invention. The system 10 includes a furnace 14 having a roll forming station 16 just upstream along a direction of conveyance C from the forming station 12 which as disclosed functions to provide press forming as is hereinafter described. Downstream from the press forming station 12 along the direction of conveyance C, the system 10 is illustrated as including a final processing station 18 at which the formed glass sheet can be slowly cooled for annealing or more rapidly cooled by quenching to provide heat strengthening or tempering.

As illustrated by continuing reference to FIG. 1, the furnace 14 has entry and exit ends 20 and 22 and includes a heating chamber 24 (FIG. 2) having a conveyor 26 for conveying glass sheets along the direction of conveyance through the furnace from the entry end to the exit end for heating. The conveyor 26 on which the glass sheets are heated can be either a conventional gas hearth or a roll conveyor on which the glass sheets are conveyed during heating from ambient temperature to a sufficiently high temperature to permit forming, which is also referred to as bending in the glass sheet industry.

The furnace exit end 22 includes the roll forming station 16 which is illustrated in FIG. 2 as having horizontally extending conveyor rolls 28 that are rotatively driven and spaced horizontally within the heating chamber along the direction of conveyance extending laterally with respect thereto to support and convey the heated glass sheets. The roll forming station 16 also includes a pair of sets 30 of bending rolls 32, with the bending roll sets 30 spaced laterally with respect to each other within the heating chamber 24 along the direction of conveyance. Each set of bending rolls 30 is supported and rotatively driven by a drive mechanism 33 with the bending rolls at progressively increasing inclinations along the direction of conveyance as illustrated by reference numerals 32ₐ, 32_{b}, 32_{c} and 32_{d} in FIG. 2. The conveyance of each heated glass sheet G along the direction of conveyance in cooperation with the bending rolls 32 provides initial forming of the glass sheet G along a direction transverse to the direction of conveyance as illustrated in FIG. 2. This forming provides the glass sheet with straight line elements that may be parallel to each other in a cylindrical shape or angled with respect to each other in a conical shape. As each location of the glass sheet along the direction of conveyance is bent from its flat shape, this bending also further bends the preceding location such that the net effect is a slightly conical shape.

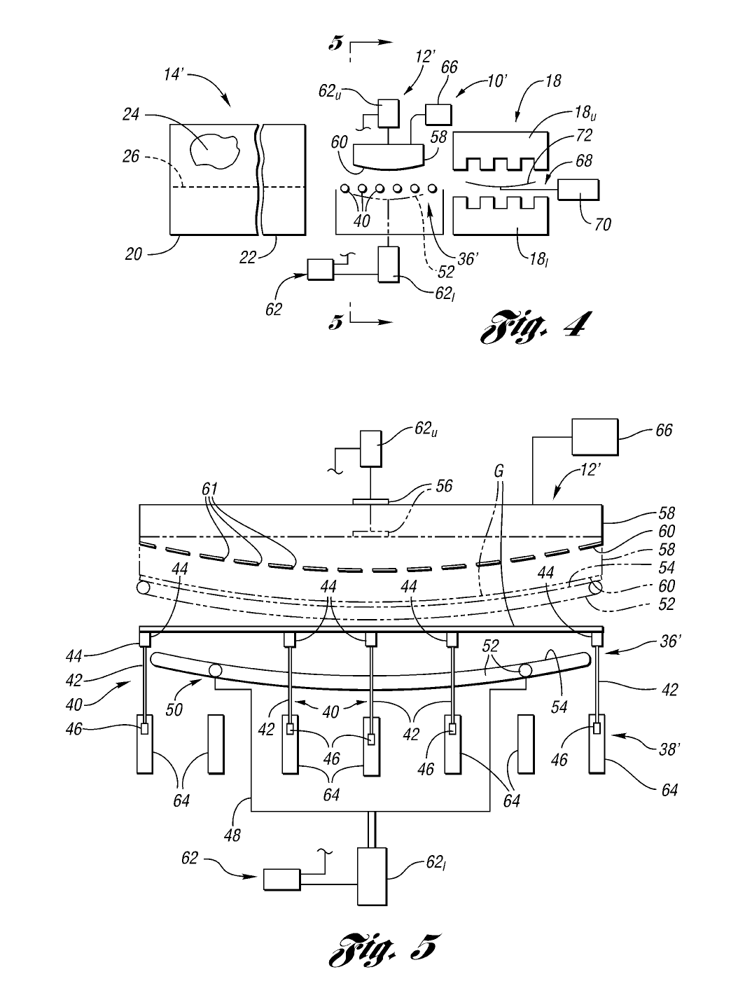

With combined reference to FIGS. 1 and 3, the press forming station 12 as previously mentioned is located externally of the furnace 14 downstream from its exit end 22 to receive the initially formed glass sheets from the roll forming station 16. More specifically, the press forming station 12 includes a conveyor having a lower wheel or roll bed 34 for receiving an initially formed glass sheet to be further formed which as disclosed is by press forming apparatus collectively indicated by 36. The lower roll bed 34 includes a lower base structure 38 and a plurality of conveyor wheel assemblies 40. Each wheel assembly 40 as is hereinafter more fully described includes a housing 42 having an upper end including a wheel 44 and having a lower end including a detachable connection 46 for detachably connecting the wheel assembly to the lower base structure 38. A drive mechanism provides rotational driving of the wheel 44 of each wheel assembly 40 upon connection thereof to the lower base structure 38. For a more detailed description of the conveyor and the drive mechanism, refer to U.S. Pat. No. 6,543,255 which has previously been incorporated by reference. Also, it should be noted that the conveyor instead of having only wheel conveyor assemblies can also have elongated roller conveyor assemblies both horizontally and/or inclined as disclosed by United States patent application Publication No. US 2011/0247367 filed on Apr. 8, 2010 by Nitschke et al. under the title Press Bending Station And Method For Bending Heated Glass Sheets, the entire disclosure of which has herein been incorporated by reference.

As illustrated in FIG. 3, a lower support 48 of the press forming apparatus 36 supports a lower forming press ring assembly 50 having a press ring 52 that has an upwardly concave shape and is received within the roll bed 34 below the wheels 44 of the wheel conveyor assemblies 40 in a ring shape thereof where no wheel assemblies are located. The construction of the lower press ring is hereinafter more fully described.

As also illustrated in FIG. 3, an upper mount 56 of the press station 12 supports an upper press mold 58 of the press forming apparatus 36. This upper press mold 58 has a downwardly facing convex forming face 60 complementary to the upwardly concave shape of the lower press ring 52.

An actuator collectively indicated by 62 in FIG. 3 provides relative vertical movement between the forming press ring assembly 50 with its press ring 52 and the roll bed 34 and between the forming mold with its press ring and the upper press mold 58 to move the heated glass sheet above the wheel bed and ultimately into pressing contact between the lower press ring and the upper press mold to press form the glass sheet as is hereinafter more fully described. As disclosed, the actuator not only moves the lower press ring 52 upwardly but also moves the upper press mold 58 downwardly so as to decrease the spacing between the lower press ring and the upper mold and thereby reduces the cycle time. However, it is possible to only move the lower press ring 52 upwardly to perform the pressing operation but with a longer cycle time.

The forming station 12 as illustrated by FIG. 3 and described above has the roll bed 34 provided with an upwardly curved shape in a direction transverse to the direction of conveyance C along which the roll bed receives the heated glass sheet corresponding to the initially formed shape provided by the roll forming station 16 illustrated in FIGS. 1 and 2. More specifically, the lower base structure 38 of the roll bed 34 includes a plurality of rails 64 that extend along the direction of conveyance and have different elevations, as provided by unshown adjusters along a direction transverse to the direction of conveyance to provide the curved shape of the roll bed. These rails 64 mount the detachable connection 46 at the lower ends of the housings 42 to support the wheels 44 and the upper ends of the housing at different elevations.

As also shown in FIG. 3, the upper press mold 58 has its forming face 60 provided with an array of holes 61 at which a vacuum is provided from a vacuum source 66 shown in FIG. 1 so as to support the formed glass sheet after the press forming and ensure forming of the glass sheet to the shape of the forming face. After the press forming, downward movement of the lower press ring 52 and upward movement of the upper press mold 58 is provided by actuator 62 by way of a lower mold actuator 62ₗ and an upper mold actuator 62ᵤ, and a shuttle 68 of the final processing station 18 is moved by an actuator 70 to move a delivery ring 72 toward the left below the upper mold 58. Termination of the vacuum provided by the vacuum source 66 may then be accompanied by the supply of pressurized gas through the holes 61 of the upper mold surface 60 to release the glass sheet onto the delivery ring 72. The shuttle actuator 70 then moves the delivery ring 72 back toward the right to the position illustrated such that the delivery ring and the formed glass sheet thereon are delivered for final processing such as slow cooling for annealing or more rapid cooling by air quenching for heat strengthening or tempering between lower and upper quench heads 18₁ and 18ᵤ.

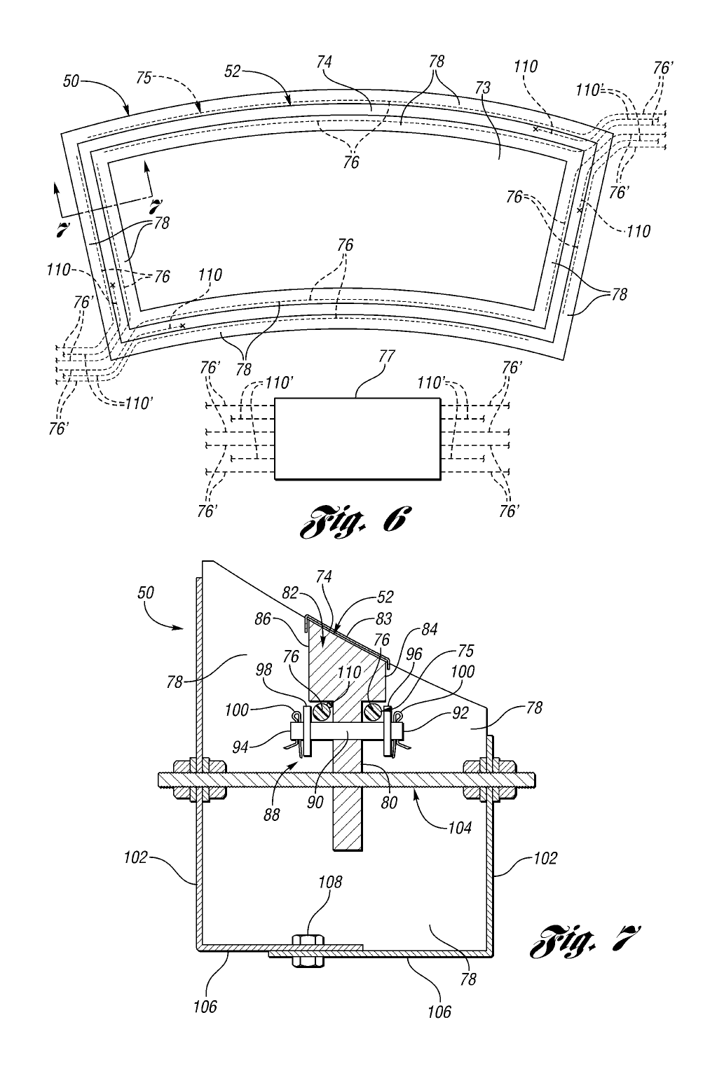

With reference to FIGS. 4 and 5, another embodiment of the glass sheet system 10′ is similar to the embodiment of FIGS. 1-3 but operates to provide positioning and forming of flat glass sheets without any preforming as with the previously described embodiment. Thus, like components thereof have the same reference numerals that are primed for the forming station 12′, furnace 14′, and press forming apparatus 36′ as well as the lower base structure 38′.

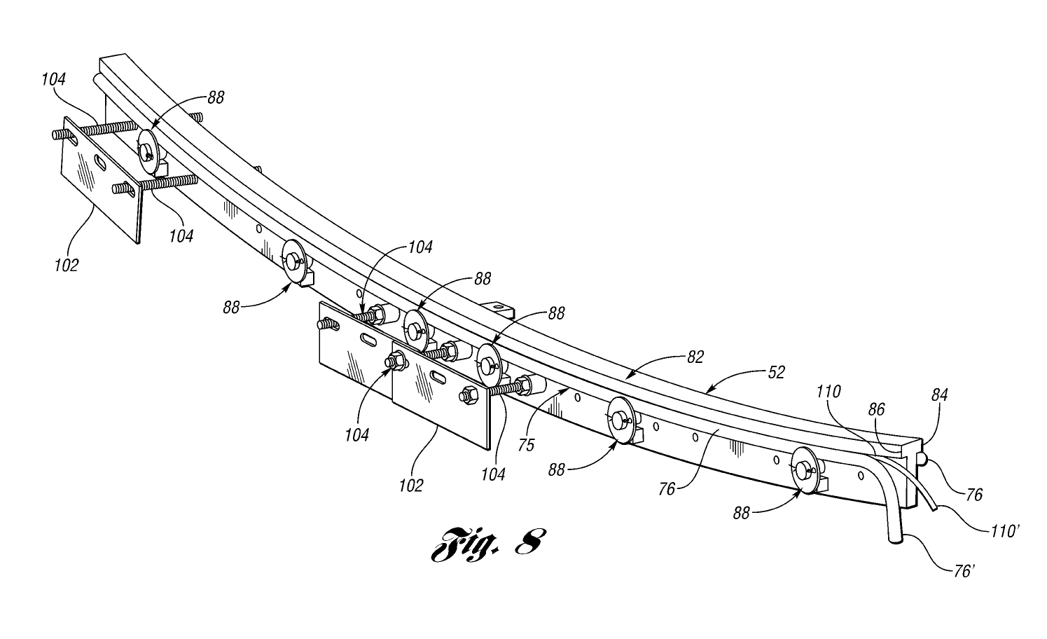

Both embodiments of the forming apparatus 36 and 36′ have the associated press ring assembly 50 located adjacent the heating furnace downstream therefrom to receive a heated glass sheet for forming. The press ring 52 of each press ring assembly 50 is mounted on the support 48 and has an open interior 73 as shown in FIG. 6. More specifically, the press ring 52 has a four-sided peripheral shape including an upwardly oriented and exposed forming face 74 for contacting the periphery of the heated glass sheet to be formed. A heater 75 extends along the peripheral shape of the press ring 52 and, as disclosed, includes a pair of heater portions 76, that are electric resistance heaters, along each of the four sides of the press ring as shown in FIGS. 6 and 7 to provide heating of the press ring. More specifically, there are two heater portions 76, respectively extending along the interior and exterior of each of the four sides of the press ring 52. Each of the heater portions 76 has a connection 76′ to a controller 77 that controls the extent of heating as described below. Insulation 78 extends along the periphery of the press ring 52 as shown in FIG. 7 within the interior, around the exterior and below the press ring to reduce heat loss from the press ring. The heater portions 76 are located between the insulation 78 and the press ring 52. This insulation 78 may be made of alumina silicate fibers formed as a batt that surrounds the press ring 52 at its interior, exterior and lower locations.

The upper mold 58 of each embodiment of the glass sheet forming system 10 and 10′ cooperates with the press ring assembly 50 to press form the heated glass sheet against the press ring forming face 74. As previously mentioned, each embodiment includes a roll conveyor provided by the roll bed 34 for conveying either a preformed glass sheet as shown in FIGS. 1-3 or a flat sheet as shown in FIGS. 4 and 5 to above the press ring assembly 50 for forming by the pressing operation as previously described.

As previously mentioned in connection with FIGS. 7 and 8, the press ring assembly 50 has the heater portions 76 extending along the press mold 52 both within its interior and around its exterior between the insulation 78 and the press ring.

As shown in FIG. 7, the press ring 52 has a cross section including a vertical stem 80 and an enlarged head 82 at the upper end of the stem, and the enlarged head defines the forming face 74 that contacts the heated glass sheet to provide the forming. This forming face 74 as shown is covered by stainless steel tape 83 to reduce glass marking and reduce heat transfer due to any differential temperature between the glass sheet and the press ring. More specifically, the enlarged head 82 of the press ring has an inner portion 84 that extends from the vertical stem 80 toward the interior of the press ring, and the enlarged head also has an outer portion 86 that extends from the vertical stem toward the exterior of the press ring.

As shown in FIGS. 7 and 8, the press ring includes connections 88 that secure the pair of heater portions 76 to the vertical stem 80 of the press ring respectively below its inner and outer portions 84 and 86 of the enlarged head 82. More specifically, each connection 88 includes a shaft 90 that extends through a hole in the vertical stem 80 of the press ring and has inner and outer ends 92 and 94. Each connection 88 as shown has inner and outer washer type retainers 96 and 98 through which the inner and outer shaft ends 92 and 94 respectively extend. Suitable clips 100 secure the retainers 96 and 98 to the shaft with the retainers contacting the heaters 76 to retain the heater portions 76 in position. The construction of the connections 88 provides the securement of the heater portions 76 to the press ring 52 and accommodates for thermal expansion and contraction involved with the heating and cooling of the press ring during its use.

As shown in FIGS. 7 and 8, the press ring assembly 50 also includes insulation positioners 102 for the insulation 78 both within the interior of the press ring 52 and at the exterior of the press ring as well as below the press ring so as to provide the positioning of the insulation on the press ring. Connectors 104 secure the positioners 102 to the vertical stem 80 of the press ring as best shown in FIG. 7. Furthermore, the positioners 102 can have lower portions 106 secured to each other by fasteners 108 or may have only vertical constructions as shown in FIG. 8.

As shown in FIGS. 6 and 7, the press ring assembly also includes at least one thermocouple 110 for sensing the temperature of the press ring 52. More specifically, as disclosed, there are four thermocouples 110 respectively located at the four sides of the press ring 52 in spaced relationships from each other with the ends of the thermocouples providing the temperature sensing at their respective spaced locations. Connections 110′ of thermocouples extend to the controller 77 so that the controller can individually control the temperature of each side of the mold as required in the manner discussed below.

As illustrated in FIG. 7, the thermocouples 110 are located between the press ring and the heater portions 76 around the exterior of the press ring. More specifically, this mounting is by contact of the thermocouples with the heater portions 76 around the exterior of the press ring and by contact with both the stem 80 of the press ring and the outer portion 86 of the enlarged head 82 of the press ring at a lower surface of the outer portion.

The sensing of the thermocouples 110 through the controller 77 controls the extent of electrical power provided to the heater portions 76 of the heater 75 through connections 76′ of the heater portions to the controller 77, to provide control of the heating. More specifically, this heating is provided so that the upwardly oriented exposed forming face 74 of the press ring 52 approximates the temperature of the periphery of the heated glass sheet. When the glass sheet is heated to a conventional forming temperature of 600° to 630° C., the sensing and the heating by the heaters provides the forming face 74 with a temperature that is no more than 75° C., preferably no more than 50° C., and most preferably no more than 30° C., above or below the temperature of the heated glass sheet periphery. It has been found that such heating reduces edge stresses when the glass sheet being formed will be subsequently annealed by slow cooling.

As shown in FIG. 6, the heater connections 76′ and thermocouple connections 110′ extend from two diagonally opposite corners of the press ring 52 that are spaced from each other by the other two diagonally opposite corners of the press ring so as to facilitate the sensing and power supplied by the controller 77, with this sensing and heating at all four sides of the press ring 52 as required to equalize the temperatures of each side of the press mold with the peripheral sides of the glass sheet being formed.

The forming stations 12 and 12′ can also have positioners that align each glass sheet with the press ring assembly 50 for the forming as disclosed by U.S. patent application Ser. No. 13/274,827, filed on Oct. 17, 2011 by David B. Nitschke et al. under the title METHOD AND APPARATUS FOR POSITIONING GLASS SHEETS FOR FORMING, and the entire disclosure thereof is hereby incorporated by reference.

While exemplary embodiments and methods are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. Glass sheet forming apparatus comprising:
a press ring assembly located adjacent a heating furnace to receive a heated glass sheet therefrom for forming and including:
a press ring for mounting on a support, the press ring having an open interior and a peripheral shape including an upwardly oriented forming face for contacting the periphery of the heated glass sheet;
a heater extending along the peripheral shape of the press ring to provide heating thereof; and
insulation extending along the periphery of the press ring within the interior, around the exterior and below the press ring to reduce heat loss from the press ring, and the heater being located between the insulation and the press ring.

2. Glass sheet forming apparatus as in claim 1 further including an upper mold that cooperates with the press ring assembly to press form the heated glass sheet.

3. Glass sheet forming apparatus as in claim 2 including a roll conveyor for conveying a preformed glass sheet to above the press ring assembly for additional forming by pressing between the press ring assembly and the upper mold.

4. Glass sheet forming apparatus as in claim 2 including a roll conveyor for conveying a flat glass sheet to above the press ring assembly for forming by pressing between the press ring assembly and the upper mold.

5. Glass sheet forming apparatus as in claim 1 wherein the press ring assembly includes a thermocouple for sensing the temperature of the press ring, and a controller that controls the heater to heat the press ring to approximately the same temperature as the periphery of the heated glass sheet.

6. Glass sheet forming apparatus as in claim 1 wherein the press ring assembly heater has heater portions both within the interior and around the exterior of the press ring between the insulation and press ring.

7. Glass sheet forming apparatus as in claim 6 wherein the press ring includes a cross section having a vertical stem and an enlarged head defining the upwardly oriented forming face that contacts the heated glass sheet to provide the forming, the enlarged head having an inner portion that extends from the stem toward the interior of the press ring, and the enlarged head having an outer portion that extends from the stem toward the exterior of the press ring.

8. Glass sheet forming apparatus as in claim 7 wherein the press ring includes connections that secure the heater portions to the stem of the press ring below the inner and outer portions of its enlarged head.

9. Glass sheet forming apparatus as in claim 8 wherein each connection includes a shaft that extends through the stem of the press ring and has inner and outer ends, and each connection having inner and outer retainers respectively secured to the inner and outer ends of the shaft to respectively secure the heater portions within the interior and around the exterior of the press ring.

10. Glass sheet forming apparatus as in claim 7 wherein the press ring assembly includes insulation positioners within the interior of the press ring and at the exterior of the press ring to position the insulation on the press ring.

11. Glass sheet forming apparatus as in claim 10 wherein the press ring assembly includes connectors that secure the insulation positioners to the stem of the press ring.

12. Glass sheet forming apparatus as in claim 7 further including thermocouples mounted at spaced locations from each other on the press ring to sense the temperature of the press ring.

13. Glass sheet forming apparatus as in claim 12 wherein the thermocouples are located between the press ring and the heater portions around the exterior of the press ring.

14. Glass sheet forming apparatus as in claim 13 wherein the thermocouples are mounted by contact with the heater portions around the exterior of the press ring and by contact with both the stem of the press ring and the outer portion of the enlarged head of the press ring at a lower surface of the outer portion, and the apparatus further including a controller for controlling the heater in response to the temperature of the press ring sensed by the thermocouples.

15. Glass sheet forming apparatus comprising:
a press ring assembly located downstream from a heating furnace to receive a heated class sheet therefrom for forming and including:
a press ring for mounting on a support, the press ring having an open interior and a peripheral shape including an upwardly oriented forming face for contacting the periphery of the heated glass sheet;
a heater having heater portions extending along the peripheral shape of the press ring within the interior and around the exterior of the press ring to provide heating thereof;
thermocouples mounted on the press ring at spaced locations from each other to sense the temperature of the press ring; and
insulation extending along the periphery of the press ring within the interior, around the exterior and below the press ring to reduce heat loss from the press ring, and the heater portions being located between the insulation and the press ring;
a controller for controlling the heater in response to the temperature of the press ring sensed by the thermocouples;
the forming apparatus including an upper mold that cooperates with the press ring assembly to press form the heated glass sheet; and
the forming apparatus including a roll bed for conveying the heated glass sheet to above the press ring assembly for forming by pressing between the press ring assembly and the upper mold.

16. A method for forming a glass sheet comprising:
heating a glass sheet within a furnace to a forming temperature;
heating a press ring of a forming station adjacent the furnace, which press ring has insulation at an interior, an exterior, and a lower surface of the press ring, to a temperature so an exposed upper forming face of the press ring approximates the forming temperature of the heated glass sheet; and
transferring the heated glass sheet from the furnace to the forming station above the press ring for forming.

17. A method for forming a glass sheet as in claim 16 wherein the forming of the heated glass sheet is performed between the press ring and an upper mold by relative vertical movement between the press ring and the upper mold.

18. A method for forming a glass sheet as in claim 16 wherein the press ring is heated by a heater having heater portions extending along the interior and exterior of the press ring and wherein the heating is controlled by at least one thermocouple that senses the temperature of the press ring.

19. A method for forming a glass sheet as in claim 17 wherein the heating is controlled by a plurality of thermocouples mounted on the press ring at spaced locations from each other to sense the temperature of the press ring and provide heating thereof to approximately the same temperature as the periphery of the heated glass sheet.

20. A method for forming a glass sheet as in claim 16 wherein the forming of the heated glass sheet is performed between the press ring and an upper mold by relative vertical movement between the press ring and the upper mold, the press ring being heated by a heater having heating portions that extend along the interior and exterior of the press ring and that are controlled by a plurality of thermocouples mounted on the press ring at spaced locations from each other to sense the temperature of the press ring.
